(19) United States
(12) Patent Application Publication
(10) Pub. No.: US 2025/0109779 A1
(43) Pub. Date: Apr. 3, 2025

(54) BUSH

(71) Applicant: Toyo Tire Corporation, Itami-shi (JP)

(72) Inventor: Yasuhiro Kuroda, Itami-shi (JP)

(73) Assignee: Toyo Tire Corporation, Itami-shi (JP)

(21) Appl. No.: 18/888,390

(22) Filed: Sep. 18, 2024

(30) Foreign Application Priority Data
Sep. 29, 2023 (JP) 2023-169439

(51) Int. Cl. F16F 13/14; F16F 1/38

(52) U.S. Cl. CPC F16F 13/14; F16F 1/3835

(57) ABSTRACT

A bottom surface of a bush is in close contact with a planar assembling surface, and two side surfaces of the bush are in close contact with two clamping surface portions of a bracket that is attached to the assembling surface. The bush includes two horizontal bases where corners provided at the bottom surface and at the two side surfaces are caused to project outward in a clamping direction with respect to extension lines of the side surfaces in a cross section perpendicular to an axial direction of the bush.

### BACKGROUND OF THE INVENTION

### 1. Field of the Invention

The present invention relates to an anti-vibration bush, and, particularly, to a bush whose static spring constant in a direction orthogonal to an axis can be increased.

### 2. Description of the Related Art

For example, a cylindrical bush that is made of an elastic material and that connects an axial member, such as a stabilizer bar, and a bracket, attached to an assembling surface of a vehicle body member, to each other is known. The axial member is inserted into a holding hole that is formed in an inner peripheral surface of the bush.

The bracket includes two clamping surface portions that clamp the bush in a direction orthogonal to the axis, a top surface portion that connects the two clamping surface portions to each other at one side of each of the two clamping surface portions, and two attaching portions where other sides of the two clamping surface portions opposite to the top surface portion are provided to be bent away from each other. By superposing the two attaching portions upon the planar assembling surface and by attaching them to the assembling surface, an outer peripheral surface of the bush is brought into close contact with the assembling surface and the bracket. Refer to Japanese Unexamined Patent Application Publication No. 2019-214287.

In the related art above, since the outer peripheral surface of the bush is set along the clamping surface portions and the assembly surface, corner portions provided at the clamping surface portions and at the assembling surface extend away from the bush due to the bends for providing the bracket with the attaching portions. Therefore, when a load in a direction orthogonal to the axis is applied to the bush and the bush is elastically deformed, a part of the bush is displaced so as to escape to the corner portions provided at the clamping surface portions and at the assembling surface, as a result of which a static spring constant of the bush in the direction orthogonal to the axis may decrease.

### SUMMARY OF THE INVENTION

The present invention has been made to solve the problems above, and it is an object of the present invention to provide a bush whose static spring constant in a direction orthogonal to an axis can be increased by restricting displacement of the bush.

To this end, according to the present invention, there is provided a bush including a bottom surface that is brought into close contact with a planar assembling surface upon which two attaching portions are superposed and to which the two attaching portions are attached; two side surfaces that are brought into close contact with two clamping surface portions that clamp the bush in a clamping direction of directions orthogonal to an axis; and two horizontal bases where corners provided at the bottom surface and at the two side surfaces are caused to project outward in the clamping direction with respect to extension lines of the side surfaces in a cross section perpendicular to an axial direction of the bush, in which the bush is a cylindrical bush that is made of an elastic material and whose inner peripheral surface is formed by a holding hole into which an axial member is to be inserted, and in which the bush has an outer peripheral surface that comes into close contact with a bracket and the assembling surface, the bracket including the two clamping surface portions, a top surface portion, and two attaching portions, the top surface portion connecting the two clamping surface portions to each other at one side of each of the two clamping surface portions, the two attaching portions being where other sides of the two clamping surface portions opposite to the top surface portion are provided to be bent outward in the clamping direction away from each other.

According to the bush of a first aspect, the bottom surface of the bush comes into close contact with the planar assembling surface, and the two side surfaces of the bush come into close contact with the two clamping surface portions of the bracket that is attached to the assembling surface. The bush includes two horizontal bases where the corners provided at the bottom surface and at the two side surfaces are caused to project outward in the clamping direction with respect to the extension lines of the side surfaces of the bush in the cross section perpendicular to the axial direction. At least a part of each corner portion provided at each clamping surface portion and at the assembling surface is embedded by each horizontal base. Therefore, displacement of a part of the bush in such a manner as to escape to the corner portions when a load in a direction orthogonal to the axis is applied to the bush can be restricted, and the static spring constant of the bush in the direction orthogonal to the axis can be increased.

A bush of a second aspect provides the following effects in addition to the effects provided by the bush of the first aspect. The corner portions provided at the clamping surface portions and at the assembling surface widen outward in the clamping direction toward the assembling surface due to the bends for providing the bracket with the attaching portions. In accordance with this widening, an amount of projection of each of the horizontal bases outward in the clamping direction increases toward the bottom surface. Therefore, the corner portions provided at the clamping surface portions and at the assembling surface can be easily embedded by the horizontal bases, and the static spring constant of the bush in the direction orthogonal to the axis can be further increased.

A bush of a third aspect provides the following effects in addition to the effects provided by the bush of the first aspect. Each of the horizontal bases is positioned closer to the bottom surface than the holding hole. Therefore, it is possible to suppress an increase in the amount of compression of the bush in the clamping direction between the clamping surface portions and the axial member caused by the projection of each horizontal base. Consequently, it is possible to suppress an increase in a torsion spring constant of the bush caused by the increase in the amount of compression, and to suppress occurrence of noise caused by the increase in the torsion spring constant.

A bush of a fourth aspect provides the following effects in addition to the effects provided by the bush of any one of the first aspect to the third aspect. In the cross section perpendicular to the axial direction of the bush, a surface of each of the clamping surface portions on a side of the bush is provided with a linear portion and a curved portion that is bent outward in the clamping direction from the linear portion and that is formed continuously with the attaching portion. In the cross section perpendicular to the axial direction, when the bottom surface of the bush in a no-load state and the assembling surface coincide with each other, each of the horizontal bases is positioned closer to the bottom surface than a boundary between the linear portion and the curved portion of the bracket attached to the assembling surface. Therefore, it is possible to suppress an increase in the amount of compression of the bush in the clamping direction between the linear portions of the two respective clamping surface portions caused by the projection of each horizontal base. Consequently, it is possible to suppress an increase in the torsion spring constant of the bush caused by the increase in the amount of compression, and to suppress occurrence of noise caused by the increase in the torsion spring constant.

A bush of a fifth aspect provides the following effects in addition to the effects provided by the bush of any one of the first aspect to the third aspect. In the cross section perpendicular to the axial direction of the bush, a surface of each of the clamping surface portions on a side of the bush is provided with a linear portion and a curved portion that is bent outward in the clamping direction from the linear portion and that is formed continuously with the attaching portion, and, of each of the clamping surface portions, a back surface of the linear portion is a linear outer surface having a straight-line form. In the cross section perpendicular to the axial direction, an outer end in the clamping direction of each of the horizontal bases of the bush in close contact with the bracket and the assembling surface is positioned outward in the clamping direction with respect to an extension line of the linear outer surface. Therefore, the corner portions provided at the clamping surface portions and at the assembling surface can be easily embedded by the horizontal bases, and the static spring constant of the bush in the direction orthogonal to the axis can be further increased.

Further, in the cross section perpendicular to the axial direction, an end of each of the horizontal bases is positioned closer to the extension line of the linear outer surface than a position that is situated at half a distance from a boundary between the curved portion and the attaching portion to the extension line of the linear outer surface. Therefore, when the bracket is attached to the assembling surface, it is possible to make it unlikely for the horizontal bases to be caught between the assembling surface and the curved portions.

### BRIEF DESCRIPTION OF THE DRAWINGS

FIG. 1 is a perspective view of a bush in an embodiment.

FIG. 2 is a front view of the bush.

FIG. 3 is a sectional view of the bush along line III-III of FIG. 2.

FIG. 4 is a sectional view of an anti-vibration unit in which the bush is assembled to a stabilizer bar, a vehicle body member, and a bracket.

FIG. 5 is a sectional view of the anti-vibration unit along line V-V of FIG. 4.

FIG. 6 is a partial enlarged sectional view of the anti-vibration unit whose portion denoted by VI of FIG. 5 is shown in an enlarged form.

### DESCRIPTION OF THE PREFERRED EMBODIMENTS

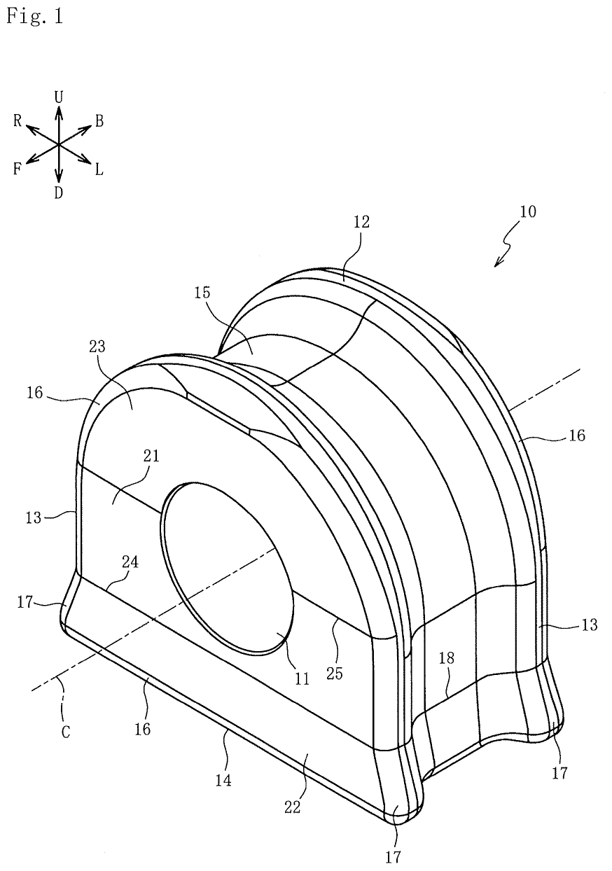

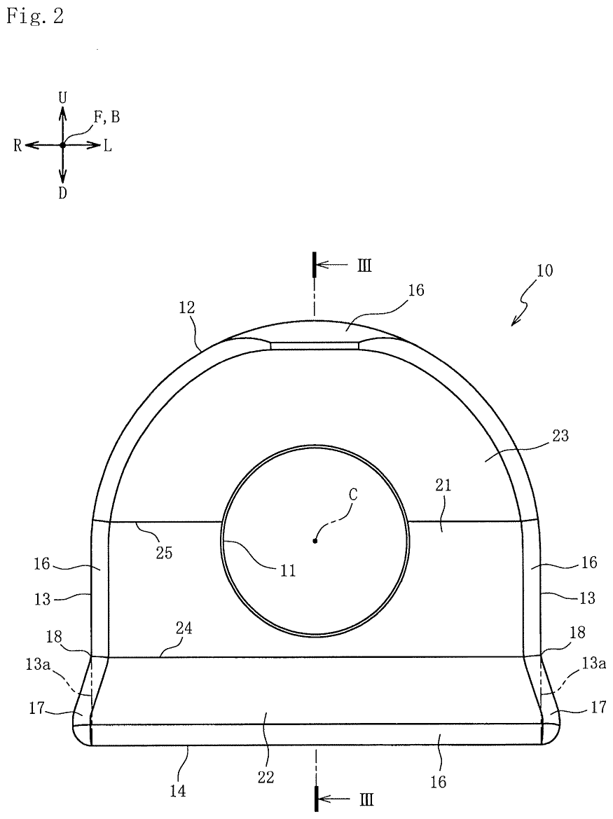

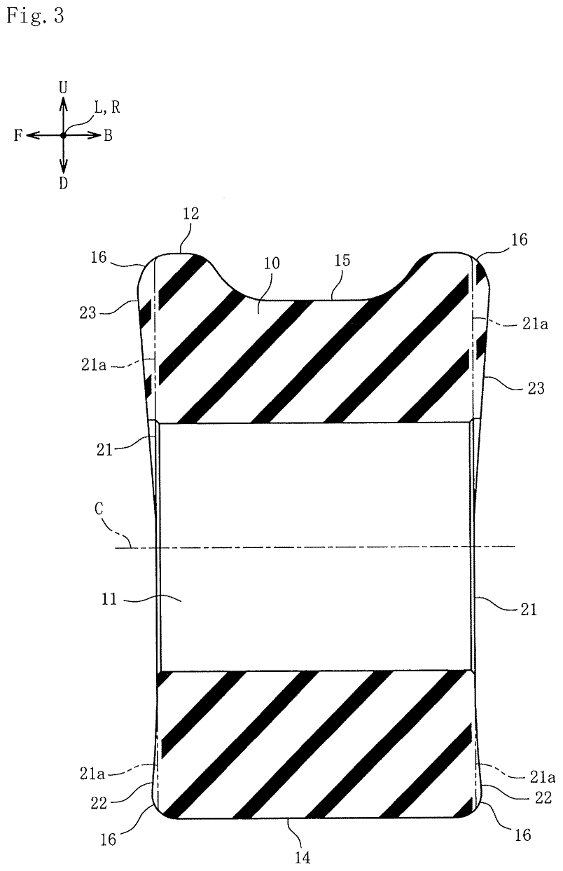

A preferred embodiment is described below with reference to the attached drawings. FIG. 1 is a perspective view of a bush 10 in an embodiment. FIG. 2 is a front view of the bush 10. FIG. 3 is a sectional view of the bush 10 along line III-III of FIG. 2.

Arrow U, arrow D, arrow L, arrow R, arrow F, and arrow B denote, respectively, an upward direction, a downward direction, a leftward direction, a rightward direction, a forward direction, and a backward direction of the bush 10. The upward and downward directions, the leftward and rightward directions, and the forward and backward directions are perpendicular to each other. The bush 10 shown in FIGS. 1 to 3 is shown as being in a no-load state in which a load other than gravity is not applied. In the description using FIGS. 1 to 3, unless otherwise specified, the bush 10 in a no-load state is described.

As shown in FIGS. 1 and 2, the bush 10 is an anti-vibration member that has a cylindrical shape surrounding an axis C, and is made of an elastic material, such as rubber or thermoplastic elastomer. In the present specification, each direction parallel to the axis C is simply called an axial direction, and each direction orthogonal to the axis C is called a direction orthogonal to the axis. Note that the forward and backward directions and the axial direction of the bush 10 are the same, and the upward and downward directions and the leftward and right directions of the bush 10 are some of the directions orthogonal to the axis. The bush 10 is formed symmetrically on the left and right sides.

A holding hole 11 that is formed in an inner peripheral surface of the bush 10 extends through the bush 10 in the axial direction. The holding hole 11 has, when viewed in the axial direction (FIG. 2), a circular shape formed around the axis C as a center. A radius from the axis C to an inner peripheral surface of the holding hole 11 is substantially the same along the entire circumference.

When viewed in the axial direction (a cross section perpendicular to the axis C (axial direction)), an outer peripheral surface of the bush 10 includes a top surface 12, two side surfaces 13, and a bottom surface 14. The top surface 12 has a semi-circular arc shape formed around the axis C as a center, and forms an upper half of the outer peripheral surface. The two side surfaces 13 extend downward and in parallel from respective sides of the top surface 12 in a peripheral direction. The bottom surface 14 is formed continuously with the two side surfaces 13 through corners.

The bottom surface 14 is constituted by a planar surface that is perpendicular to the upward and downward directions. In the cross section perpendicular to the axis C, the side surfaces 13 are formed perpendicular to the bottom surface 14. A recessed surface 15 whose central portion in the axial direction is recessed inward in a direction orthogonal to the axis is formed in the outer peripheral surface (in the top surface 12 and the side surfaces 13) of the bush 10 excluding the bottom surface 14.

Further, end portions of the outer peripheral surface of the bush 10 in the axial direction are constituted by curved surfaces 16 that smoothly connect to end surfaces of the bush 10 in the axial direction. That is, the curved surfaces 16 are inclined toward the center in the axial direction with increasing distance to the end surfaces of the bush 10 in the axial direction in a direction orthogonal to the axis.

The bush 10 includes two horizontal bases 17 where the corners provided at the bottom surface 14 and at the two side surfaces 13 are caused to project outward in the leftward and rightward directions with respect to extension lines 13a of the side surfaces 13 in the cross section perpendicular to the axis C. The recessed surface 15 and the curved surfaces 16 are also formed at the horizontal bases 17.

Each horizontal base 17 is positioned closer to the bottom surface 14 than the holding hole 11. Boundaries 18 between the side surfaces 13 and the respective horizontal bases 17 are, when viewed from a direction perpendicular to the side surfaces 13, straight lines perpendicular to the upward and downward directions. The amounts of projections of the horizontal bases 17 outward in the leftward and rightward directions increase toward the bottom surface 14 from the boundaries 18. In the cross section perpendicular to the axis C, outer peripheral surfaces of the horizontal bases 17 while inclining in straight lines toward the bottom surface 14 from the boundaries 18, have lower ends of the inclinations connected to the bottom surface 14 by smooth curved lines.

As shown in FIGS. 1 and 3, an end surface of the bush 10 in the axial direction is formed by a flat surface 21 and a first base 22 and a second base 23, the flat surface 21 being perpendicular to the axis C and the first base 22 and the second base 23 being inclined outward in the axial direction with increasing distance to the flat surface 21 and the holding hole 11. In the bush 10 in the present embodiment, two end surfaces in the axial direction are formed identically.

Each flat surface 21 is provided on the left and right with respect to the holding hole 11. Each first base 22 is provided below the holding hole 11. Each second base 23 is provided above the holding hole 11. Note that FIG. 3 shows by alternate long and two short dashes lines extension lines 21a where the flat surfaces 21 are extended toward both sides in the upward and downward directions with respect to the holding hole 11. Parts that are situated outward in the axial direction with respect to the extension lines 21a are the first bases 22 and the second bases 23.

Each first base 22 is inclined outward in the axial direction toward a lower side up to a corresponding one of the curved surfaces 16 of the outer peripheral surface of the bush 10. Each second base 23 is inclined outward in the axial direction toward an upper side up to a corresponding one of the curved surfaces 16. The second bases 23 project by a larger amount in the axial direction than the first bases 22.

As shown in FIG. 2, each boundary 24 between the flat surface 21 and the first base 22 is a straight line that is perpendicular to the upward and downward directions when viewed in the axial direction, and is positioned below the holding hole 11. Each boundary 25 between the flat surface 21 and the second base 23 is a straight line that is perpendicular to the upward and downward directions when viewed in the axial direction, and is positioned below an upper end of the holding hole 11 and above the axis C.

The first bases 22 and the second bases 23 are formed over the entire length in the leftward and rightward directions at the end surfaces of the bush 10 in the axial direction. Further, the first bases 22 and the second bases 23 are formed such that, excluding portions where the holding hole 11 is formed, sectional shapes thereof perpendicular to the leftward and rightward directions are formed identically over the entire length in the leftward and rightward directions. This makes it possible to facilitate molding of the bush 10 by using a die that cracks at the center in the leftward and rightward directions.

The positions where the boundaries 24, which are starting points of the inclination of the first bases 22, have been extended in the leftward and rightward directions and the positions where the boundaries 18, which are starting points of the horizontal bases 17, exist are substantially the same. Compared to a case in which these positions differ from each other, the bush 10 including the first bases 22 and the horizontal bases 17 can be easily molded.

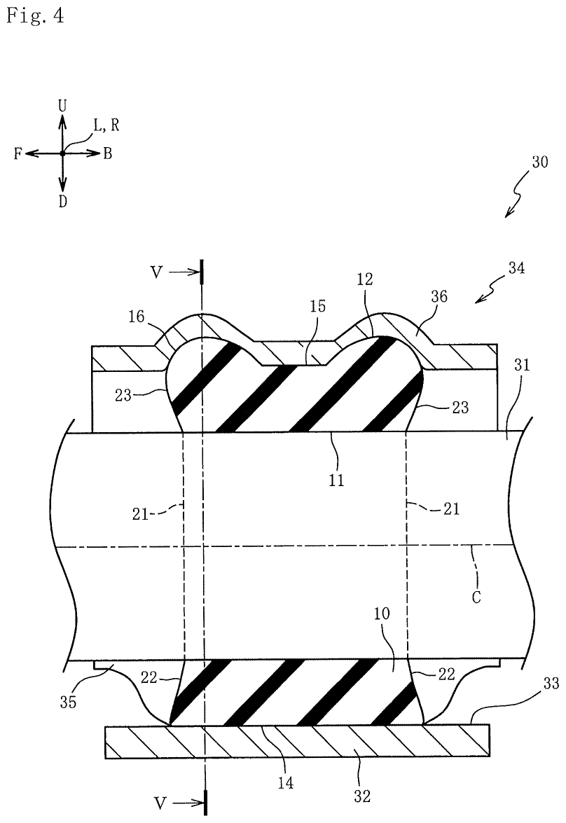

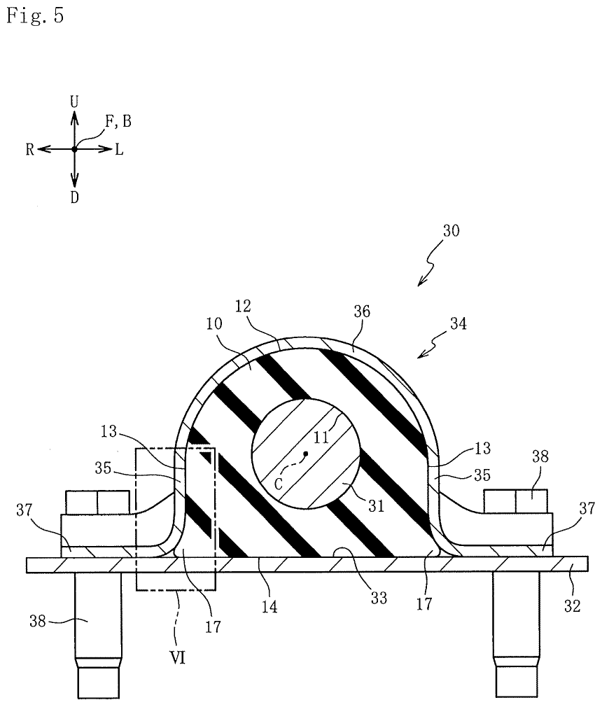

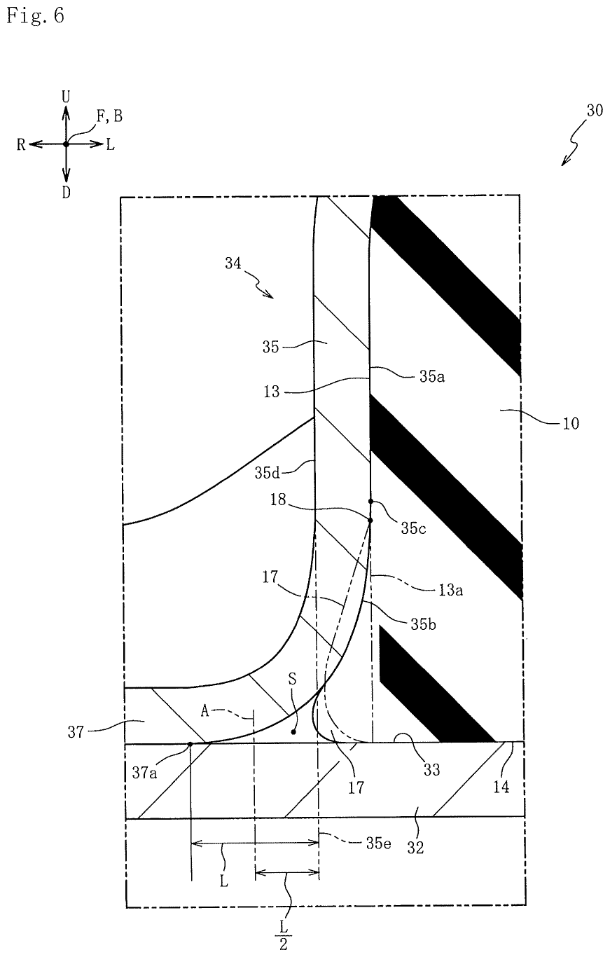

Next, an anti-vibration unit 30 including the bush 10 is described with reference to FIGS. 4 to 6. FIG. 4 is a sectional view of the anti-vibration unit 30 in which the bush 10 is assembled to a stabilizer bar 31 (axial member), a vehicle body member 32, and a bracket 34. FIG. 5 is a sectional view of the anti-vibration unit 30 along line V-V of FIG. 4. FIG. 6 is a partial enlarged sectional view of the anti-vibration unit 30 whose portion denoted by VI of FIG. 5 is shown in an enlarged form.

Note that, in the present embodiment, upward and downward directions, leftward and rightward directions, and forward and backward directions of the anti-vibration unit 30 (the bush 10) coincide with upward and downward directions, forward and backward directions, and leftward and rightward directions of a vehicle in which the anti-vibration unit 30 is installed. However, each of these directions of the anti-vibration unit 30 may differ from each of the directions of the vehicle. The anti-vibration unit 30 is formed symmetrically on the left and right sides.

The stabilizer bar 31 is a member for suppressing rolling of a vehicle body, and is disposed along the leftward and rightward directions of the vehicle. The stabilizer bar 31 is an axial steel member having a circular shape in cross section. The stabilizer bar 31 is inserted into and fitted to the holding hole 11 of the bush 10, and an outer peripheral surface of the stabilizer bar 31 and the inner peripheral surface of the bush 10 (the holding hole 11) are in close contact with each other.

The anti-vibration unit 30 is a unit for elastically supporting the stabilizer bar 31 by the vehicle body, and includes the above-described bush 10, an assembling surface 33 of the vehicle body member 32, and the bracket 34. The vehicle body member 32 is a flat plate member including the planar assembling surface 33, and is made of a metal or synthetic resin. The vehicle body member 32 is fixed such that a back surface of the assembling surface 33 is superposed upon the vehicle body. The bottom surface 14 of the bush 10 is in close contact with the assembling surface 33 in a non-adhesive manner. Note that the vehicle body member 32 need not be used, and the assembling surface 33 may be constituted by a part of the vehicle body.

The bracket 34 is a member for assembling the bush 10 to the vehicle body while the bush 10 into which the stabilizer bar 31 is inserted is compressed in a direction orthogonal to the axis between the bracket 34 and the assembling surface 33. The bracket 34 is made of a metal or synthetic resin. The bracket 34 includes two clamping surface portions 35 that clamp the bush 10 in the leftward and rightward directions (clamping directions), a top surface portion 36 that is connected to upper sides of the two clamping surface portions 35, and two attaching portions 37 where lower sides of the two clamping surface portions 35 are provided to be bent outward in the leftward and rightward directions away from each other. The bracket 34 is formed such that, by bending one plate material, the clamping surface portions 35, the top surface portion 36, and the attaching portions 37 are integrally molded.

The top surface portion 36 is a part that is in close contact with the top surface 12 of the bush 10. Similarly to the top surface 12, an inner surface and an outer surface of the top surface portion 36 have an arc shape in the cross section perpendicular to the axis C (when viewed in the axial direction). The inner surface and the outer surface of the top surface portion 36 have an uneven shape along the axis C so as to match the shapes of the recessed surface 15 and the curved surfaces 16 of the top surface 12.

Each clamping surface portion 35 is a part that is in close contact with each side surface 13 of the bush 10 in a non-adhesive manner. A bush-10-side inner surface of each clamping surface portion 35 is constituted by linear portions 35a and curved portions 35b that are bent outward in the left direction or the right direction from the linear portions 35a in the cross section perpendicular to the axis C. The two left and right linear portions 35a are parallel to each other. Each curved portion 35b connects a lower end of the linear portion 35a and the attaching portion 37.

An outer surface of each clamping surface portion 35 includes linear outer surfaces 35d that are in the form of a straight line and that are provided at back surfaces of the linear portions 35a in the cross section perpendicular to the axis C. Each linear outer surface 35d and each linear portion 35a are parallel to each other. A back surface of each curved portion 35b is formed by a curved line along the curved portion 35b in the cross section perpendicular to the axis C.

The inner surface and the outer surface of each clamping surface portion 35 have an uneven shape along the axis C so as to match the shape of the recessed surface 15 and the curved surface 16 of the side surface 13. The interval between the two linear portions 35a in the leftward and rightward directions is substantially equal to a dimension in the leftward and rightward directions between the two side surfaces 13 of the bush 10 in a no-load state. Since the amount of compression of the bush 10 in the leftward and rightward directions by the bracket 34 can be decreased, it is possible to decrease a torsion spring constant of the bush 10. Although, when the torsion spring constant becomes too large, noise tends to be produced when a load is applied to the bush 10, it is possible to make it unlikely for noise to be produced by decreasing the torsion spring constant.

Each attaching portion 37 is attached to the assembling surface 33 by fixing bolts 38 to the vehicle body with each attaching portion 37 being superposed upon the assembling surface 33, the bolts 38 extending upward and downward through the attaching portions 37 and the vehicle body member 32. In an assembled state in which each attaching portion 37 is attached to the assembling surface 33, the bush 10 is primarily compressed in the upward and downward directions between the assembling surface 33 and the top surface portion 36.

More specifically, in the assembled state, the bush 10 is primarily compressed above and below the stabilizer bar 31, and the compressed portion expands in the axial direction with respect to a no-load state. In particular, of an end surface of the bush 10 in the axial direction that is a portion that is situated away from the stabilizer bar 31, the assembling surface 33, and the bracket 34, a central portion in a direction orthogonal to the axis tries to bulge.

In a cross section including the axis C, as the bush 10 expands, a portion that bulges outward in the axial direction with respect to a contact surface where the bush 10 and the assembling surface 33 or the bracket 34 contact each other has almost no effect on the static spring constant of the bush 10 with respect to compression deformation in a direction orthogonal to the axis. The bulging portion increases the volume of the bush 10. Note that compression deformation of the bush 10 refers to further compression of the bush 10 in a direction orthogonal to the axis due to an input of vibration into the anti-vibration unit 30 from a state in which the bush 10 has been compressed by assembling the bush 10 to the stabilizer bar 31, the assembling surface 33, and the bracket 34.

Each end surface of the bush 10 in the axial direction in the present embodiment is provided with the first base 22 and the second base 23 at a position above and at a position below the stabilizer bar 31 (the holding hole 11), respectively, and at positions where the bush 10 expands in the axial direction by upward and downward compressions. In the no-load state (the state in FIG. 3 etc.), with increasing distance to the stabilizer bar 31 in the upward and downward directions, the first bases 22 and the second bases 23 are each inclined outward in the axial direction up to the curved surfaces 16 that contact the assembling surface 33 or the bracket 34.

Due to the first bases 22 and the second bases 23, at locations above and below the stabilizer bar 31, it is possible to make it unlikely for the central portions of the end surfaces of the bush 10 in the axial direction to bulge, and to increase the area of contact between the bush 10 and the assembling surface 33 or the bracket 34. As a result, it is possible to, while suppressing an increase in the volume of the bush 10, increase the static spring constant of the bush 10 with respect to compression deformation in the upward and downward directions.

For example, even when the bush 10 is maximally compressed and deformed in the upward and downward directions in order to prevent the bush 10 from contacting a member that is positioned near the assembling surface 33 or the bracket 34, there may be a case in which the bush 10 is required not to protrude in the axial direction from the assembling surface 33 or the bracket 34. Even if, in order to achieve such a requirement, it is difficult to increase the volume of the bush 10, it is possible to increase the static spring constant of the bush 10 in the upward and downward directions by the first bases 22 and the second bases 23.

The first bases 22 and the second bases 23 are each formed on a corresponding one of the two end surfaces of the bush 10 in the axial direction. Therefore, compared to when a first base 22 and a second base 23 are formed on only one end surface in the axial direction, it is possible to further increase the static spring constant of the bush 10 in the upward and downward directions.

The outer peripheral surface of the bush 10 is not adhered to the assembling surface 33 and the bracket 34 with an adhesive. Therefore, the bush 10 that has been compressed and deformed in a direction orthogonal to the axis may slide in the axial direction with respect to the assembling surface 33 and the bracket 34 while the bush 10 expands in such a manner as to escape in the axial direction.

However, the bush 10 in the present embodiment is capable of receiving a load in the upward and downward directions from the stabilizer bar 31 by the first bases 22 and the second bases 23 that each widen with decreasing distance to the contact surface where the bush 10 contacts the assembling surface 33 or the bracket 34. Therefore, when the bush 10 is compressed and deformed in the upward and downward directions, it is possible to make it unlikely for the bush 10 to slide in the axial direction with respect to the assembling surface 33 or the bracket 34. Thus, it is possible to reduce, for example, changes in the static spring constant of the bush 10 caused by the sliding.

Note that the first bases 22 and the second bases 23 within a region that overlaps the holding hole 11 when viewed in the upward and downward directions easily contribute to the increase in the static spring constant of the bush 10 in the upward and downward directions, whereas the first bases 22 and the second bases 23 that are outside this region are unlikely to contribute to the increase in the static spring constant of the bush 10 in the upward and downward directions.

However, the first bases 22 and the second bases 23 outside the region above are capable of making it unlikely for the bush 10 to slide in the axial direction with respect to the assembling surface 33 or the bracket 34. Therefore, by providing the first bases 22 and the second bases 23 not only within the region above but also outside the region above, when the bush 10 is compressed and deformed in the upward and downward directions, it is possible to widen a range in which the bush 10 is unlikely to slide in the axial direction with respect to the assembling surface 33 or the bracket 34.

Further, the first bases 22 and the second bases 23 are formed along the entire length in the leftward and rightward directions on the end surfaces of the bush 10 in the axial direction. Therefore, when the bush 10 is compressed and deformed in the upward and downward directions, it is possible to make it unlikely for the bush 10 to slide in the axial direction with respect to the assembling surface 33 or the bracket 34 over the entire length in the leftward and rightward directions. Thus, it is possible to further reduce, for example, changes in the static spring constant of the bush 10 caused by the sliding.

At a location below the stabilizer bar 31, the bush 10 that is compressed in the upward and downward directions between the stabilizer bar 31 and the assembling surface 33 primarily expands in the axial direction along the planar assembling surface 33. In contrast, at a location above the stabilizer bar 31, the bush 10 that is compressed in the upward and downward directions between the stabilizer bar 31 and the bracket 34 expands not only in the axial direction but also in, for example, a direction orthogonal to the axis so as to closely contact the uneven shape of the inner surface of the bracket 34.

Therefore, when the bush 10 is brought into an assembled state from the no-load state, changes in the amount of projection in the axial direction from the flat surfaces 21 become larger at the first bases 22 on the lower side than at the second bases 23 on the upper side. However, in a previously no-load state, the maximum amount of projection in the axial direction from the flat surfaces 21 is larger at a part of each second base 23 than at each first base 22. Therefore, in the assembled state, it is possible to bring the maximum amount of projection of the first bases 22 and the maximum amount of projection of the second bases 23 close to each other. As a result, by bringing the static spring constant of the bush 10 in the downward direction and the static spring constant of the bush 10 in the upward direction close to each other, it is possible to properly balance the static spring constants in the upward and downward directions.

In the assembled state, due to the bends (the curved portions 35b) for providing the bracket 34 with the attaching portions 37, the corner portions provided at the clamping surface portions 35 and the assembling surface 33 widen outward in the leftward and rightward directions from the extension lines 13a of the clamping surface portions 35 with decreasing distance to the assembling surface 33. Therefore, gaps S are formed between the corners provided at the side surfaces 13 and at the bottom surface 14 of the bush 10 and the corner portions provided at the clamping surface portions 35 and the assembling surface 33.

When a load in a direction orthogonal to the axis is applied to the bush 10 and the bush 10 is elastically deformed, a part of the bush 10 is displaced so as to escape to the gaps S, as a result of which the static spring constant of the bush 10 in the direction orthogonal to the axis may decrease. When, in order to ensure the static spring constant, a compression ratio in the direction orthogonal to the axis of the bush 10 in the assembled state is increased or the hardness of an elastic material constituting the bush 10 is increased, the bush 10 tends to wear out and thus its durability is decreased.

In contrast, since the bush 10 of the present embodiment includes the horizontal bases 17 where the corners provided at the side surfaces 13 and at the bottom surface 14 are caused to project outward in the leftward and rightward directions (toward the gaps S), a part of each gap S can be embedded by each horizontal base 17. Therefore, when a load in a direction orthogonal to the axis is applied to the bush 10, a part of the bush 10 can be restricted from being displaced so as to escape to the gaps S and thus the static spring constant of the bush 10 in the direction orthogonal to the axis can be increased. Further, it no longer becomes necessary to increase the compression ratio of the bush 10 or to increase the hardness of an elastic material for increasing the static spring constant of the bush 10, as a result of which it is possible to suppress wear of the bush 10 and to ensure its durability.

The amounts of projections of the horizontal bases 17 outward in the leftward and rightward directions increase from the boundaries 18 between the horizontal bases 17 and the side surfaces 13 toward the bottom surface 14. Since the gaps S (the corner portions provided at the clamping surface portions 35 and the assembling surface 33) widen, the gaps S can be easily embedded by the horizontal bases 17, and the static spring constant of the bush 10 in the direction orthogonal to the axis can be further increased. In addition, due to the similarity of their shapes, when the bracket 34 is attached to the assembling surface 33, it is possible to make it unlikely for the horizontal bases 17 to be caught between the assembling surface 33 and the curved portions 35b of the bracket 34.

Since each horizontal base 17 is positioned closer to the bottom surface 14 than the holding hole 11, it is possible to suppress an increase in the amount of compression of the bush 10 in the leftward and rightward directions between the clamping surface portions 35 and the stabilizer bar 31 caused by the projection of each horizontal base 17. Therefore, it is possible to suppress an increase in the torsion spring constant of the bush 10 caused by the increase in the amount of compression, and to suppress occurrence of noise caused by the increase in the torsion spring constant. In addition to providing this effect, it is possible to suppress an increase in a load produced when the bush 10 into which the stabilizer bar 31 has been inserted enters an inner side of the bracket 34, and to increase work efficiency when the bush 10 is to be brought into an assembled state.

FIG. 6 shows by an alternate long and two short dashes line one horizontal base 17 in a no-load state in a state in which, in the cross section perpendicular to the axis C, the bottom surface 14 and one side surface 13 of the bush 10 in a no-load state coincide with the assembling surface 33 and the linear portion 35a, respectively. In the cross section, the horizontal base 17 (the boundary 18) is positioned closer to the bottom surface 14 than the boundary 35c between the linear portion 35a and the curved portion 35b. Therefore, it is possible to suppress an increase in the amount of compression of the bush 10 in the leftward and rightward directions between the two linear portions 35a caused by the projection of the horizontal base 17. As a result, it is possible to suppress occurrence of noise caused by an increase in the torsion spring constant and to further increase work efficiency when the bush 10 is to be brought into an assembled state.

In particular, it is preferable that the boundaries 18 be positioned 1 mm or more toward the bottom surface 14 than the boundaries 35c. In this case, even if, for example, manufacturing errors of the bush 10 or the bracket 34 are taken into consideration, it is possible to suppress occurrence of noise caused by an increase in the torsion spring constant and to increase work efficiency when the bush 10 is to be brought into an assembled state. Further, it is preferable that the distance between each boundary 35c and each boundary 18 in the upward and downward directions be less than or equal to 3 mm. This makes it possible to more easily embed the gaps S by the horizontal bases 17.

In the cross section perpendicular to the axis C, outer ends in the leftward and rightward directions of the horizontal bases 17 of the bush 10 in the assembled state are positioned outward in the leftward and rightward directions with respect to the extension lines 35e of the linear outer surfaces 35d. Therefore, the gaps S can be more easily embedded by the horizontal bases 17, and the static spring constant of the bush 10 in the direction orthogonal to the axis can be further increased.

A position that is situated at half (L/2) a distance L in the leftward and rightward directions from a boundary 37a between the curved portion 35b and the attaching portion 37 to the extension line 35e of the linear outer surface 35d is defined as position A. The end of each horizontal base 17 is positioned closer to its corresponding extension line 35e than the position A. Therefore, when the bracket 34 is attached to the assembling surface 33, it is possible to make it unlikely for the horizontal bases 17 to be caught between the assembling surface 33 and the curved portions 35b of the bracket 34.

As described above, it is preferable that the shape of each horizontal base 17 in the no-load state be set such that, in the cross section perpendicular to the axis C, in the assembled state, the end of each horizontal base 17 is positioned between the extension line 35e and the position A. Specifically, first, the area of an interference portion between the bracket 34 and each horizontal base 17 in the no-load state in a state in which, in the cross section perpendicular to the axis C, the bottom surface 14 and each side surface 13 of the bush 10 in the no-load state coincide with a corresponding one of the assembling surface 33 and the linear portions 35a is calculated. The area of the interference portion above is set (is adjusted) such that when each horizontal base 17 is expanded in the gap S from the no-load state by an amount corresponding to this area, the end of each horizontal base 17 is positioned between its corresponding extension line 35e and the position A.

Although the present invention has been described above on the basis of an embodiment, the present invention is not limited in any way to the embodiment above, and it can be easily inferred that various improvements and modifications are possible within a scope that does not depart from the spirit of the present invention. For example, the shape of the top surface 12 and the shape of the top surface portion 36 when viewed in the axial direction are not limited to arc shapes, and may be, for example, polygonal shapes.

The recessed surface 15 of each side surface 13 or the top surface 12 need not be provided. The two side surfaces 13 or the linear portions 35a of the two clamping surface portions 35 are not limited to being parallel to each other, and, for example, an interval between them may increase toward the bottom surface 14 or the attaching portions 37.

Although, in the embodiment above, the case in which the bush 10 is a stabilizer bush that connects the stabilizer bar 31 to the assembling surface 33 and the bracket 34 has been described, it is not necessarily limited thereto. For example, the stabilizer bar 31 may be replaced by an axial member that is attached to a vibration source side, such as an engine or a motor, and the axial member may be connected to the assembling surface 33 and the bracket 34 by the bush 10. Note that the axial member may be attached to a vibration reception side, such as a vehicle body, and the assembling surface 33 and the bracket 34 may be provided at the vibration source side. The shape of the holding hole 11 or the shape of the outer peripheral surface may be changed as appropriate in accordance with the shape of, for example, the axial member to which the bush 10 is assembled.

Although, in the embodiment above, the case in which an end of each horizontal base 17 in the assembled state is positioned between the extension line 35e and the position A has been described, it is not necessarily limited thereto. For example, an end of each horizontal base 17 may be positioned on an inner side in the leftward and rightward directions with respect to the extension line 35e, or may be positioned on an outer side in the leftward and rightward directions with respect to the position A. The present invention is not limited to the case in which a part of each gap S is embedded by the horizontal base 17, and thus each gap S may be embedded in its entirety by the horizontal base 17.

Each boundary 18 that is an upper end of the horizontal base 17 may be positioned above the boundary 35c, or may be positioned above a lower end of the holding hole 11. The two left and right horizontal bases 17 are not limited to being symmetrically formed on the left and right sides, and thus may be asymmetrically formed on the left and right sides.

Although, in the embodiment above, the case in which the first bases 22 that are positioned below the holding hole 11 are inclined outward in the axial direction toward the downward direction has been described, it is not necessarily limited thereto. The first bases 22 may be positioned in a first direction of the directions orthogonal to the axis with respect to the holding hole 11 and may be inclined outward in the axial direction toward the first direction, the first direction not being limited to the downward direction. For example, the first direction may be, of the directions orthogonal to the axis, the upward direction, the right direction, the left direction, or oblique directions with respect to the upward direction, the downward direction, the left direction, and the right direction.

The second bases 23 may be positioned in a second direction opposite to the first direction with respect to the holding hole 11, and may be inclined outward in the axial direction toward the second direction. For example, when the first direction is the upward direction, the second direction is the downward direction. Note that the second bases 23 need not be provided. Bases like the first bases 22 or the second bases 23 may be provided in a direction differing from the first direction or the second direction of the directions orthogonal to the axis with respect to the holding hole 11.

The positions of the boundaries 24 described in the embodiment above where the first bases 22 start to incline and the positions of the boundaries 25 described in the embodiment above where the second bases 23 start to incline may be moved in parallel in a direction orthogonal to the axis. The shapes of the boundaries 24 and 25 are not limited to linear shapes perpendicular to the upward direction and the downward direction (the first direction and the second direction) when viewed in the axial direction. For example, the shapes of the boundaries 24 and 25 may be shapes formed by curved lines or straight lines that are inclined with respect to the upward direction and the downward direction, or may be formed by combining a straight line and a curved line.

Although, in the embodiment above, the case in which the sectional shapes of the first bases 22 and the sectional shapes of the second bases 23 are the same over the entire length in the leftward and rightward directions has been described, it is not necessarily limited thereto. For example, the first bases 22 and the second bases 23 may bulge in the axial direction at the center with respect to two ends in the leftward and rightward directions, or may be recessed in the axial direction at the center in the leftward and rightward directions. Alternatively, each first base 22 and each second base 23 may be only partly provided in the leftward and rightward directions.

Although, in the embodiment above, the case in which the two end surfaces of the bush 10 in the axial direction are identically formed has been described, the two end surfaces may differ from each other. For example, one end surface of the bush 10 in the axial direction may only be a flat surface.

### DESCRIPTION OF REFERENCE NUMERALS

10 bush
11 holding hole
13 side surface
13a extension line of side surface
14 bottom surface
17 horizontal base
31 stabilizer bar (axial member)
33 assembling surface
34 bracket
35 clamping surface portion
35a linear portion
35b curved portion
35c boundary between linear portion and curved portion
35d linear outer surface
35e extension line of linear outer surface
36 top surface portion
37 attaching portion
37a boundary between curved portion and attaching portion

What is claimed is:

1. A bush comprising:
a bottom surface that is brought into close contact with a planar assembling surface upon which two attaching portions are superposed and to which the two attaching portions are attached;
two side surfaces that are brought into close contact with two clamping surface portions that clamp the bush in a clamping direction of directions orthogonal to an axis; and
two horizontal bases where corners provided at the bottom surface and at the two side surfaces are caused to project outward in the clamping direction with respect to extension lines of the side surfaces in a cross section perpendicular to an axial direction of the bush,
wherein the bush is a cylindrical bush that is made of an elastic material and whose inner peripheral surface is formed by a holding hole into which an axial member is to be inserted, and
wherein the bush has an outer peripheral surface that comes into close contact with a bracket and the assembling surface, the bracket including the two clamping surface portions, a top surface portion, and two attaching portions, the top surface portion connecting the two clamping surface portions to each other at one side of each of the two clamping surface portions, the two attaching portions being where other sides of the two clamping surface portions opposite to the top surface portion are provided to be bent outward in the clamping direction away from each other.

2. The bush according to claim 1,
wherein an amount of projection of each of the horizontal bases outward in the clamping direction increases toward the bottom surface.

3. The bush according to claim 1,
wherein each of the horizontal bases is positioned closer to the bottom surface than the holding hole.

4. The bush according to claim 1,
wherein, in the cross section perpendicular to the axial direction,
a surface of each of the clamping surface portions on a side of the bush is provided with a linear portion and a curved portion that is bent outward in the clamping direction from the linear portion and that is formed continuously with the attaching portion, and
when the bottom surface of the bush in a no-load state and the assembling surface coincide with each other, each of the horizontal bases is positioned closer to the bottom surface than a boundary between the linear portion and the curved portion of the bracket attached to the assembling surface.

5. The bush according to claim 1,
wherein, in the cross section perpendicular to the axial direction,
a surface of each of the clamping surface portions on a side of the bush is provided with a linear portion and a curved portion that is bent outward in the clamping direction from the linear portion and that is formed continuously with the attaching portion,
of each of the clamping surface portions, a back surface of the linear portion is a linear outer surface having a straight-line form, and
an outer end in the clamping direction of each of the horizontal bases of the bush in close contact with the bracket and the assembling surface is positioned outward in the clamping direction with respect to an extension line of the linear outer surface, and is positioned closer to the extension line of the linear outer surface than a position that is situated at half a distance from a boundary between the curved portion and the attaching portion to the extension line of the linear outer surface.
